(19) United States
(12) Patent Application Publication
(10) Pub. No.: US 2022/0299620 A1
(43) Pub. Date: Sep. 22, 2022

(54) SPATIAL IMAGE GENERATING DEVICE, OBJECT DETECTION DEVICE AND OBJECT DETECTION METHOD

(71) Applicant: NIPPON TELEGRAPH AND TELEPHONE CORPORATION, Tokyo (JP)

(72) Inventors: Tomoki MURAKAMI, Musashino-shi, Tokyo (JP); Hirantha ABEYSEKERA, Musashino-shi, Tokyo (JP); Shunsuke SARUWATARI, Musashino-shi, Tokyo (JP); Takeru FUKUSHIMA, Musashino-shi, Tokyo (JP); Yusuke IWASAKI, Musashino-shi, Tokyo (JP); Takashi WATANABE, Musashino-shi, Tokyo (JP)

(73) Assignee: NIPPON TELEGRAPH AND TELEPHONE CORPORATION, Tokyo (JP)

(21) Appl. No.: 17/636,558

(22) PCT Filed: Aug. 19, 2020
(86) PCT No.: PCT/JP2020/031206

§ 371 Date: Feb. 18, 2022

(30) Foreign Application Priority Data
Aug. 23, 2019 (JP) 2019-153055

(51) Int. Cl. G01S 13/06; G01S 5/02; G02B 30/56

(52) U.S. Cl. CPC G01S 13/06; G01S 5/0221; G01S 5/0226; G02B 30/56

(57) ABSTRACT

A spatial image generation apparatus includes: a propagation channel information measurer that measures propagation channel information of a target area from radio signals delivered between transmitting and receiving stations; a learned model generator that generates a learned model for generating a spatial image of the target area from the newly input propagation channel information using the propagation channel information and image information obtained by imaging the target area with a camera; and an image generator that generates the spatial image of the target area by inputting the propagation channel information newly input from the propagation channel information measurer to the learned model. The object detection apparatus includes: the spatial image generation apparatus; and an object detector that detects an object in the target area from the spatial image generated by the image generator using an image analysis method.

### TECHNICAL FIELD

The present invention relates to a spatial image generation apparatus, an object detection apparatus, and an object detection method for generating a spatial image of a target area using radio signals and detecting presence/absence of an object in the target area.

### BACKGROUND ART

There is a position providing service of a wireless terminal station using a received signal strength indicator (RSSI), which is average signal strength information in used frequencies of radio signals and is acquired by a wireless LAN system, as one service applying the RSSI. In order to realize the service, the wireless terminal station measures RSSIs from beacon signals transmitted from a plurality of wireless base stations and estimates the position of the wireless terminal station from the plurality of acquired RSSIs (NPL 1, for example).

Moreover, a method of detecting human behavior (breathing, motions, and the like) from variation properties of RSSI has also been studied as another application service in addition to the position estimation (NPL 2, for example).

Studies for detection using propagation channel information (channel state information (CSI)) of each subcarrier in orthogonal frequency division multiplexing (OFDM) on the assumption of a system using OFDM in addition to RSSIs, which are average signal strength information of a used frequency, have also been advanced in order to improve detection accuracy. The propagation channel information includes amplitude information and phase information of each OFDM subcarrier in a propagation path between an antenna of a wireless base station and an antenna of a wireless terminal station and further information regarding relative values among the antennas. The amount of the information is much larger than that of RSSIs, and NPL 3, for example, thus reports that detection such as position estimation and activity estimation is significantly improved using the propagation channel information. Moreover, a further improvement in detection accuracy and an increase in application range have advanced with development of machine learning in recent years.

### CITATION LIST

### Non Patent Literature

NPL 1: Navarro Eduardo, 2011, “Wi-Fi Localization Using RSSI Fingerprinting”, California Polytechnic State University, United States of America. http://digitalcommons.calpoly.edu/cpesp/17/(17 Aug. 2011)

NPL 2: Wang, Wei, et al. “Understanding and Modeling of WiFi Signal Based Human Activity Recognition.” Proceedings of the 21st annual international conference on mobile computing and networking. ACM, 2015.

NPL 3: Yang, Zheng, Zimu Zhou, and Yunhao Liu, “From RSSI to CSI: Indoor localization via channel response.” ACM Computing Surveys (CSUR) 46.2 (2013): 25.

### SUMMARY OF THE INVENTION

### Technical Problem

In general, detection accuracy and a time required for detection are important elements to be evaluated for providing a service of an object detection system using radio signals. As described as the background art, CSI requires a significantly large amount of information as compared with RSSIs and is also configured with information of different dimensions such as frequency, time, and space, and a calculation load related to the detection thus increases. Moreover, in a case in which machine learning is applied, a calculation load increases relating to a large amount of training data required to create a learned model for detection and creation of a model. Degradation of detection accuracy and a requirement of a time for detection are conceivable depending on a specification of an apparatus that actually performs the detection for the above reasons.

An object of the present invention is to provide a spatial image generation apparatus, an object detection apparatus, and an object detection method for generating a spatial image of a target area from propagation channel information of radio signals and detecting presence/absence of an object in the target area from the spatial image.

### Means for Solving the Problem

A first aspect in accordance with the present invention provides a spatial image generation apparatus including: a propagation channel information measurer configured to measure propagation channel information of a target area from radio signals delivered between transmitting and receiving stations; a learned model generator configured to generate a learned model for generating a spatial image of the target area from the propagation channel information newly input using the propagation channel information and image information obtained by imaging the target area with a camera; and an image generator configured to generate the spatial image of the target area by inputting the propagation channel information newly input from the propagation channel information measurer to the learned model.

A second aspect in accordance with the present invention provides an object detection apparatus including: the spatial image generation apparatus according to the first aspect of the present invention; and an object detector configured to detect an object in a target area from the spatial image generated by the image generator using an image analysis method.

A third aspect in accordance with the present invention provides an object detection method including: measuring propagation channel information of a target area from radio signals delivered between transmitting and receiving stations; generating a learned model for generating a spatial image of the target area from the propagation channel information newly input using the propagation channel information and image information obtained by imaging the target area with a camera; generating the spatial image of the target area by inputting the propagation channel information newly input in the measuring of the propagation channel information to the learned model; and detecting an object in the target area from the spatial image generated in the generating of the spatial image using an image analysis method.

### Effects of the Invention

According to the present invention, it is possible to create a spatial image of a target area from propagation channel information using machine learning and further to detect an object with high accuracy at a high speed through identification processing of the spatial image when object detection is performed from the propagation channel information of radio signals.

### BRIEF DESCRIPTION OF DRAWINGS

FIG. 1 is a diagram illustrating an example of an object detection system.

FIG. 2 is a diagram illustrating a configuration example of a transmitting station 10.

FIG. 3 is a diagram illustrating a configuration example of a receiving station 20.

FIG. 4 is a diagram illustrating a configuration example of an object detection apparatus 30.

FIG. 5 is a diagram illustrating an example of propagation channel information.

### DESCRIPTION OF EMBODIMENTS

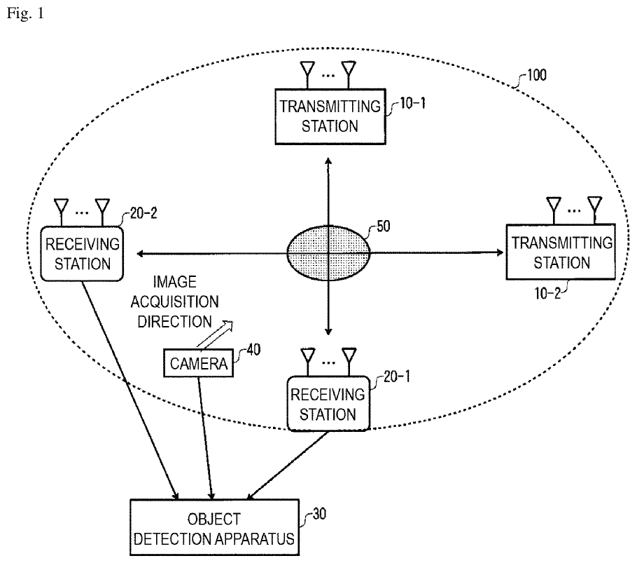

FIG. 1 illustrates an example of an object detection system. In FIG. 1, the object detection system includes a transmitting station 10-1, a transmitting station 10-2, a receiving station 20-1, a receiving station 20-2 in a target area 100, and an object detection apparatus 30 connected to the receiving station 20-1, the receiving station 20-2, and a camera 40 and detects an object 50 in the target area 100.

Here, the transmitting station 10-1 and the transmitting station 10-2 will be described as a transmitting station 10 when common description thereof is given or will be described as transmitting stations 10-1 and 10-2 in a case in which specific blocks are indicated. Similar description will also be used for the receiving station 20-1 and the receiving station 20-2. Note that, although the example of two sets of transmitting stations and receiving stations is illustrated in the drawing, a configuration of one set or three or more sets may also be employed. Alternatively, a combination of one transmitting station and a plurality of receiving stations may be employed.

The object detection apparatus 30 detects the object 50 that is present between a transmitting station 10 and a receiving station 20 in the target area 100. For example, each of a radio signal transmitted from the transmitting station 10-1 to the receiving station 20-1 and a radio signal transmitted from the transmitting station 10-2 to the receiving station 20-2 is affected by the object 50 that is present in the target area 100. Thus, the object detection apparatus 30 analyzes an amplitude and a phase between transmitting and receiving antennas, which is propagation channel information (CSI) measured by the receiving station 20-1 and/or the receiving station 20-2, and detects the object 50 in the target area 100 by the following method. Note that, although the transmitting stations 10 and the receiving stations 20 face each other with the object 50 therebetween in FIG. 1, it is not necessary for the transmitting stations 10 and the receiving stations 20 to physically face each other.

First, a learned model generator in the object detection apparatus 30 receives image information imaged with the camera 40 and propagation channel information as inputs, generates training data to be used for machine learning, and further generates a learned model for generating a spatial image of the target area 100 from the new propagation channel information. Next, an image generation/object detector generates a spatial image of the target area 100 using the learned model generated by the learned model generator and the newly input propagation channel information, analyzes the spatial image, and detects presence/absence of the object 50.

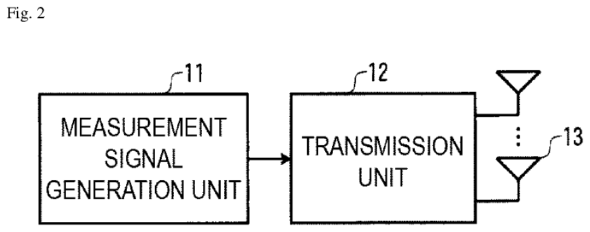

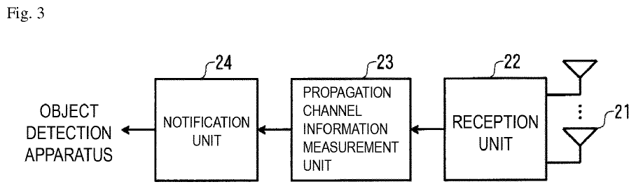

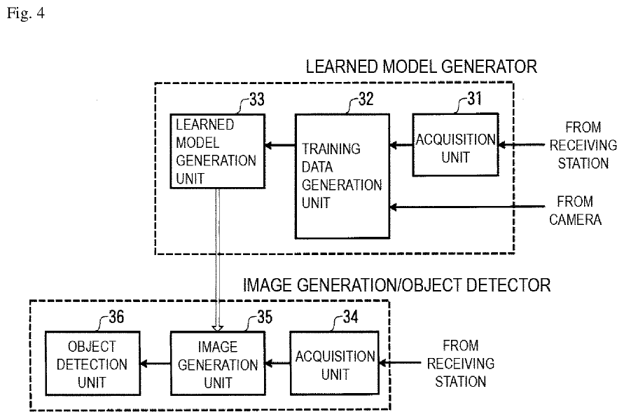

FIG. 2 illustrates a configuration example of the transmitting station 10. FIG. 3 illustrates a configuration example of the receiving station 20. FIG. 4 illustrates a configuration example of the object detection apparatus 30. Note that FIGS. 2 to 4 illustrate only main functional blocks related to the present embodiment, and other functional blocks included in the transmitting stations 10, the receiving stations 20, and the object detection apparatus 30 are omitted.

In FIG. 2, the transmitting station 10 includes a measurement signal generation unit 11, a transmission unit 12, and a plurality of antennas 13. Here, the transmitting station 10 corresponds to a wireless base station in a wireless LAN system, for example.

The measurement signal generation unit 11 generates a measurement signal for the receiving station 20 to measure propagation channel information such as a signal (a training signal for measuring a propagation path response or the like) known to the transmitting station 10 and the receiving station 20 and outputs the known signal to the transmission unit 12.

The transmission unit 12 converts the measurement signal generated by the measurement signal generation unit 11 into a wireless LAN signal, for example, directed to a subordinate receiving station 20 and transmits the wireless LAN signal from the plurality of antennas 13. Here, the plurality of antennas 13 may or may not have directionality.

In FIG. 3, the receiving station 20 includes a plurality of antennas 21, a reception unit 22, a propagation channel information measurement unit 23, and a notification unit 24. Here, the receiving station 20 corresponds to a wireless terminal station in a wireless LAN system, for example.

The plurality of antennas 21 receive wireless LAN signals transmitted from the transmitting station 10. Note that the antenna 21 may or may not have directionality.

The reception unit 22 converts wireless LAN signals received by the plurality of antennas 21 into measurement signals that can be handled by the propagation channel information measurement unit 23 and outputs the measurement signals.

The propagation channel information measurement unit 23 measures an amplitude, a phase, and the like between antennas, for example, as propagation channel information from the measurement signals input from the reception unit 22 and outputs the measurement results to the notification unit 24.

The notification unit 24 converts the propagation channel information input from the propagation channel information measurement unit 23 into a form that can be delivered to the object detection apparatus 30 and notifies the object detection apparatus 30 of the propagation channel information.

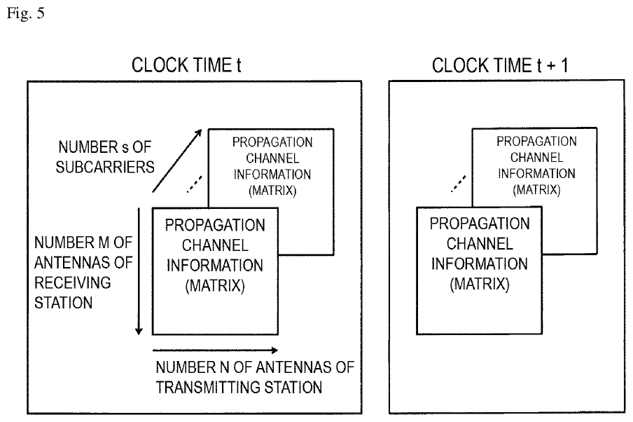

Note that the propagation channel information used in the present invention is represented by the number M of the receiving station antennas, the number N of the transmitting station antennas, the number s of subcarriers, and a dimension of a clock time as illustrated in FIG. 5.

In FIG. 4, the object detection apparatus 30 includes an acquisition unit 31, a training data generation unit 32 and a learned model generation unit 33 as the learned model generator, and includes an acquisition unit 34, an image generation unit 35 and an object detection unit 36 as the image generation/object detector. Note that, although the acquisition unit 31 and the acquisition unit 34 are described separately for convenience, the acquisition unit 31 and the acquisition unit 34 are commonly configured.

The acquisition unit 31 acquires the propagation channel information provided as a notification from the receiving station 20 during a learned model generation period and outputs the propagation channel information to the training data generation unit 32. The training data generation unit 32 generates training data using the propagation channel information and the image information input from the camera 40. At this time, the training data generation unit 32 uses a generative adversarial network (GAN), which is a type of generative machine learning model, in order to generate and visualize a spatial image that does not yet exist from the propagation channel information. The GAN can create a large amount of training data not only by creating the training data from actually measured data but also using new image information copied by a calculator as training data. The learned model generation unit 33 generates a learned model corresponding to propagation channel information on the basis of the training data.

The acquisition unit 34 acquires the propagation channel information provided as a notification from the receiving station 20 during the object detection period and outputs the propagation channel information to the image generation unit 35. The image generation unit 35 inputs the new propagation channel information input from the acquisition unit 34 to the learned model generated by the learned model generation unit 33 to generate a spatial image and outputs the spatial image to the object detection unit 36.

The object detection unit 36 performs object detection on the spatial image input from the image generation unit 35 using an image analysis method. Note that information (detection information) regarding the detection result may be internally held or may be output to the outside. Moreover, it is possible to use a known technique such as clustering based on machine learning as a determination method, and detailed description thereof will thus be omitted.

In this manner, the learned model generator generates a learned model from training data, which is a pair of image information of the target space from the camera and propagation channel information at that time, and the image generation/object detector inputs the new propagation channel information to the learned model and generates a new spatial image, thereby performing object detection.

Also, value extraction may be performed through processing of an average value, a median value, or the like of elements such as the antennas of the transmitting stations 10, the antennas of the receiving stations 20, subcarriers, and a time in the propagation channel information. Also, a method of enlarging the size of a matrix illustrated in FIG. 5 by simply combining propagation channel information of the plurality of transmitting stations 10 and receiving stations 20 or a method of combining weighted propagation channel information may be used. It is thus possible to improve accuracy of object detection.

Also, although the configuration in FIG. 4 is a configuration in which the propagation channel information measured by the receiving station 20 is directly provided as a notification to the object detection apparatus 30, the propagation channel information may be compressed and then provided as a notification. Here, although the object detection apparatus 30 may perform object detection after decompressing the compressed information, it is also possible to generate a spatial image directly from the compressed propagation channel information and to perform detection if a learned model that uses the compressed propagation channel information as an input and uses a camera image as an output is used. Note that, in regard to compressed information of the propagation channel information, there are a method used in IEEE 802.11ac and an information extraction method.

### REFERENCE SIGNS LIST

10 Transmitting station
11 Measurement signal generation unit
12 Transmission unit
13 Antenna
20 Receiving station
21 Antenna
22 Reception unit
23 Propagation channel information measurement unit
24 Notification unit
30 Object detection apparatus
31, 34 Acquisition unit
32 Training data generation unit
33 Learned model generation unit
35 Image generation unit
36 Object detection unit
40 Camera
100 Target area

1. A spatial image generation apparatus comprising:
a propagation channel information measurer configured to measure propagation channel information of a target area from radio signals delivered between transmitting and receiving stations;
a learned model generator configured to generate a learned model for generating a spatial image of the target area from the propagation channel information newly input using the propagation channel information and image information obtained by imaging the target area with a camera; and
an image generator configured to generate the spatial image of the target area by inputting the propagation channel information newly input from the propagation channel information measurer to the learned model.

2. The spatial image generation apparatus according to claim 1, wherein the learned model generator is configured to use a generative adversarial network (GAN) that not only creates training data from actually measured data of the image information but also uses, as the training data, new image information copied by a calculator to create a large amount of training data when the training data is generated using the propagation channel information and the image information to generate the learned model corresponding to the propagation channel information on the basis of the training data.

3. An object detection apparatus comprising:
the spatial image generation apparatus according to claim 1; and
an object detector configured to detect an object in the target area from the spatial image generated by the image generator using an image analysis method.

4. An object detection method comprising:
measuring propagation channel information of a target area from radio signals delivered between transmitting and receiving stations;
generating a learned model for generating a spatial image of the target area from the propagation channel information newly input using the propagation channel information and image information obtained by imaging the target area with a camera;
generating the spatial image of the target area by inputting the propagation channel information newly input in the measuring of the propagation channel information to the learned model; and
detecting an object in the target area from the spatial image generated in the generating of the spatial image using an image analysis method.

5. The object detection method according to claim 4, wherein, in the generating of the learned model, a generative adversarial network (GAN) is used that not only creates training data from actually measured data of the image information but also uses, as the training data, new image information copied by a calculator to create a large amount of training data when the training data is generated using the propagation channel information and the image information to generate the learned model corresponding to the propagation channel information on the basis of the training data.
